(19) United States
(12) Patent Application Publication
(10) Pub. No.: US 2012/0245273 A1
(43) Pub. Date: Sep. 27, 2012

(54) STRUCTURAL PROFILE MEMBERS FOR PRODUCING HOUSEHOLD UTENSILS, AND METHOD FOR PRODUCING SAID PROFILE MEMBERS

(75) Inventor: Alberto Campos Beceiro, Sant Andreu de Llavaneres (Barcelona) (ES)

(73) Assignee: Kloner, S.L., Barcelona (ES)

(21) Appl. No.: 13/391,015

(22) PCT Filed: Jun. 24, 2010
(86) PCT No.: PCT/ES2010/070427

§ 371 Date: Jun. 7, 2012

(30) Foreign Application Priority Data
Aug. 17, 2009 (ES) P200930601

(51) Int. Cl. C09J 167/02; B29C 47/06; B05D 5/00; C08L 67/02

(52) U.S. Cl. 524/504; 524/605; 524/513; 264/173.16; 427/258

(57) ABSTRACT

The invention relates to profile members made from recycled plastic material, such as handles, stands, frames and legs of ironing boards, indoor and outdoor clotheshorses, etc. The main component of the plastic profile members is a polymer having a high modulus of elasticity, such as PET, polyamide, ABS, etc., as well as traces of materials that contain fibreglass. The structural profile members are produced by mixing and subsequent extrusion.

### OBJECT OF THE INVENTION

The present invention, as expressed in the title of this specification, refers to structural profiles for the manufacture of household utensils and the process for obtaining those profiles.

These are structural profiles for the manufacture of household utensils and furniture, such as brooms and mop handles; ironing boards' supports, frameworks and legs, interior and exterior clothes dryers, shopping carts, cleaning carts, garden furniture, etc.

The structural profiles of the invention are manufactured with materials from plastic residues in which its major component is a polymer of high elastic modulus, such as PET, polyamide, ABS, etc, and high elastic modulus fiber residues such as fiberglass, carbon, boron, basalt, aramid, etc.

The structural profiles are obtained by kneading and subsequent extrusion with some particular characteristics.

### BACKGROUND OF THE INVENTION

Currently, profiles for the production of household utensils such as brooms and mop handles are made of steel, aluminium or wood, and generally with a diameter of around 22 mm; those made of steel being abundant because of their reduced cost and low weight which makes them very easy to handle.

The properties that are sought in these handles are:

### 1.—Ergonomic Properties:

a.—light

b.—easy to handle

c.—handle which is adaptable to the hands of the user

### 2.—Mechanical Properties:

a.—rigidity

b.—resistance to corrosion

c.—durability

The profiles used as structural elements in other household utensils, such as ironing boards, clothes dryers, shopping carts, cleaning carts, are usually made of steel or aluminium because of their rigidity and their capacity to be welded.

On the other hand, there is multitude of residues in the market from food containers mainly formed by PET, mixed or non-mixed with other polymers, such as PE or PP and occasionally barrier polymers, such as EVOH. There are also large quantities of ABS residues from the scrapping of electrical appliances and computer equipment.

There is also a large amount of high elastic modulus fiber residues in the market due the difficulties encountered in its elimination, such as fiberglass or carbon from its own production or its utilization in the production of composites, before and after its impregnation with the resins used in the manufacture of those composites, such as resins of unsaturated polyester or epoxy resins. The residues of the composites themselves, once their service life is ended, are also abundant.

These residues, due to the difficulties of recycling, constitute a serious problem for the environment and consequently they are abundant and cheap.

### DESCRIPTION OF THE INVENTION

The structural profiles for the manufacture of household utensils, such as brooms and mop handles, are characterized in that they are at least partly manufactured with some first residues and preferably with bottle residues and other PET pieces with remnants of fiberglass residues.

Those above mentioned first residues comprise parts of materials, such as the ones described in the background section of the invention. Structural profiles, manufactured with the residual composition described, have the following advantages with regard to what is currently available in the market:

They can be manufactured in greater diameters, with an important improvement of their ergonomics, without substantially increasing their weight.
They have a notably lower cost.
They do not rust, as they not have metals in their composition.
They can be recycled again at the end of their service life.
They protect the environment, as they contribute to the recycling of the aforementioned polymers and the fiberglass residues.

More specifically, the composition of the structural profiles of the invention to obtain the handles is the following:

The central tube comprises between 30% and 70% fiberglass and preferably between 40 and 60% fiberglass.

Between 30% and 70% of PET residues that can contain up to a 20% of PE to improve their resistance to impact. Preferably, between 40% and 60% of PET.

In the event that the residues contain proportions over 5% of other non-polar polymers, such as PE or PP, an adhesive polymer will be added. In a preferred embodiment, the adhesive polymer of the exterior and interior layers of the container or corresponding profile of the present invention is selected among the group comprising:

Polyethylene/polypropylene polymers, or mixes of both, containing graft polar groups;
Copolymers of ethylene and acrylic or methacrylic acid;
Copolymer of ethylene and acrylates or acetates;
Derivatives of glycidyl methacrylate; and
Copolymers of styrene-ethylene-butadiene-styrene (SEBS) containing graft polar groups.

In a more preferred embodiment, the graft polar groups are maleic anhydride or acrylic acid. In an even more preferred embodiment, the graft polar groups are in a proportion of less than 15% in weight with regard to the adhesive polymer.

In another preferred embodiment, the graft polar group is maleic anhydride and is in a smaller proportion than 5% in the adhesive polymer weight. In an even more preferred embodiment, the proportion of maleic anhydride is less than 3% in weight.

In another preferred embodiment, the graft polar group is acrylic acid and is in a proportion of less than 7% in the adhesive polymer weight.

The process to obtain the tubular structural profiles, such as handles for brooms and the like, with the defined recycled materials, has the following stages:

A first stage of pre-treatment of the raw materials.

In this first stage the polymer residue should be crushed by the use of grinding mills suitable for these materials and cleaned by means of the already known technologies of washing/drying or dry cleaning with air flow.

Fiberglass, if presented in remnants, should be cut to a measure of around 3 to 20 mm, preferably between 5 and 15 mm, so that it can be subsequently fed, in a continuous dosage, into an extrusion machine. In the event that it comes from resinated composites, these should be ground until defibrated, the resin turn into a powder form and the fiberglass at a size between 1 and 10 mm. The composite will be used in its entirety, without separating the two components.

A second stage of kneading.

In this stage the extrusion of the pre-treated materials can be carried out by melt-kneading, by means of well known devices such as the ones provided with twin screw extruders (sharp or not) although it is not entirely limited to this last possibility. Among other possibilities there is also double shaft extrusion equipment. On the other hand, equipment that has a single shaft extrusor may be preferred, following an intensive mixture or kneading device that carries out the kneading and granulating-extrusion operations.

Another possibility is using an extrusor/mixer, preferably with cutting shafts, and preferably with intermediate gas extraction by vacuum pump, being also adequate other types of multiple shafts extruders/mixers suitable for PET.

Depending on the composition of the polymer residue used, especially if it is a matter of mixtures of polar and non-polar polymers, such as PET+PE or PET+PP; it may be necessary, in the extrusion stage, to utilize some adhesive polymer among the ones already known and existing in the market, which facilitates the blend among the polymers of diverse polarity.

A third stage of co-extrusion.

In this stage, once the homogenized mixture of components is obtained, the profile can be finally shaped, either like a circular crown or other different geometric shapes, such as hexagonal, octagonal, ellipsoidal, etc., that will contribute to their gripping ergonomics or respond to the required design of the utensil that is going to be part of, either in a separate process, in a profile extrusion line from the mixture in a pellet shape or, preferably, following the process of kneading, with or without the aid of a molten pump to increase the pressure in the extrusion mouthpiece, if necessary.

With the purpose to embellish the surface of the profile and to be able to endow it of elements that contribute to its grip or are required for subsequent assembly operations, the extrusion mouthpiece will preferably have two or more layers in co-extrusion of total or partial coating of the handle with coloured or non coloured polymers of diverse nature such as PET, PP, PC, and TPE (thermoplastic elastomers).

These coating layers could also be applied later to the extrusion of the profile by means of the already known profile coating technologies through thermoplastics or coating processes with lacquer, immersion or spray painting or other known methods.

A first embodiment of a handle is the following:
Central profile of circular section:

### Diameter 26 mm

### Wall Thickness 1.8 mm

### Composition:

PET flakes from bottles 48%
Cut fiberglass residues 48%
PTW Dupont Elvaloy compatibilizer Additive 2%

### Coating:

PET flakes from pigmented bottles

### Thickness 0.2 mm

Total weight 212 g/m
Elastic Modulus of the profile: 15 GPa
A second embodiment of another handle is the following:
Central profile of circular section:

### Diameter 26 mm

### Wall Thickness 1.8 mm

### Composition:

Flakes of residues from pizza containers formed by 75% of PET, 20% of PE and 5% of EVOH: 47%,
Cut fiberglass fiber residues: 50%
PTW Dupont Elvaloy compatibilizer Additive 3%

### Coating:

PET flakes from pigmented bottles

### Thickness: 0.2 mm

Total weight: 216 g/m
Elastic modulus of the profile: 9.7 GPa

On the other hand, although the abbreviations used for the polymers are internationally known, each one of them is described as follows:

PP, polypropylene; PE polyethylene; PEHD, high density polyethylene; PELD, low density polyethylene; PC, polycarbonate; PET polyethylene terephthalate; ABS, acrylonitrile.

1.-16. (canceled)

17. A structural profile for the manufacture of household utensils, which is manufactured using at least partly materials from plastic residues, comprising as major components:
a polymer of a high elastic modulus,
and residues from materials containing fiberglass.

18. The profile of claim 17, comprising:
from 30% (w) to 70% (w) of fiberglass residues; and
from 30% (w) to 70% (w) of PET residues.

19. The profile of claim 17, comprising from 40% (w) to 60% (w) of PET residues.

20. The profile of claim 17, further comprising residues containing other non-polar polymers.

21. The profile of claim 20, wherein the non-polar polymers comprise up to 20% of PE.

22. The profile of claim 20, comprising:
non-polar polymers in a proportion over 5% (w), and
an adhesive polymer.

23. The profile of claim 22, wherein the adhesive polymer is selected from a group consisting of:
polyethylene/polypropylene polymers, or mixtures of both, containing graft polar groups;
copolymers of ethylene and acrylic or methacrylic acid;
copolymers of ethylene and acrylates or acetates;
derivatives of glycidyl methacrylate; and
copolymers of styrene-ethylene-butadiene-styrene (SEBS) containing graft polar groups.

24. The profile of claim 23, wherein the graft polar groups are in a proportion of less than 15% (w) with regard to the adhesive polymer.

25. The profile of claim 23, wherein the graft polar groups are maleic anhydride.

26. The profile of claim 25, wherein the graft polar group is maleic anhydride, in a proportion of less than 5% (w) of the adhesive polymer.

27. The profile of claim 26, wherein the graft polar group is maleic anhydride, in a proportion of less than 3% (w) of the adhesive polymer.

28. The profile of claim 23, wherein the graft polar groups are acrylic acid.

29. The profile of claim 28, wherein the graft polar group is acrylic acid, in a proportion of less than 7% (w) of the adhesive polymer.

30. A process for obtaining a structural profile for the manufacture of household utensils, comprising the following stages:
a first stage of pre-treating polymer residues comprising:
crushing using grinding mills; and
cleaning;
a second stage of kneading, in which an extrusion of the pre-treated materials is carried out; and
a third stage of co-extrusion, in which once the homogenized mixture of components is obtained in the second stage, the corresponding structural profile is shaped to its final form.

31. The process of claim 30, wherein an adhesive polymer is added in the second stage of kneading for facilitating the blending of polymers showing diverse polarities.

32. The process of claim 30, wherein total or partial coating of a handle of the profile is carried out by applying more than one coating layer in the stage of co-extrusion, for embellishing the surface of the profile and for allowing the profile to be endowed of elements contributing to its grip or subsequent assembly operations.

33. The process of claim 32, wherein the coating layers are applied later to the co-extrusion of the profile.
